(19) United States
(12) Patent Application Publication
(10) Pub. No.: US 2005/0244042 A1
(43) Pub. Date: Nov. 3, 2005

(54) FILTERING AND VISUALIZATION OF A MULTIDIMENSIONAL VOLUMETRIC DATASET

(75) Inventors: Saad Ahmed Sirohey, Pewaukee, WI (US); Rakesh Mohan Lal, Waukesha, WI (US); Matthieu Denis Ferrant, Saint Remy les Chevreuse (FR); Paulo Ricardo dos Santos Mendonca, Clifton Park, NY (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/709,355

(22) Filed: Apr. 29, 2004

(51) Int. Cl. G06K 9/00

(52) U.S. Cl. 382/131; 382/154

(57) ABSTRACT

The method comprises: accessing the multi-dimensional dataset; generating a plurality of differential operators for the multi-dimensional dataset using a discrete approximation of an analytic function; and forming a plurality of geometric responses based on a plurality of differential operators resultant from the generating. The method optionally further includes isolating a selected region of interest from the multi-dimensional dataset; the selected region of interest comprising a subset of the imaging volume.

### BACKGROUND OF THE INVENTION

This invention relates generally to imaging systems and specifically to a system and method for processing imaging data.

Visualization of anatomical data acquired by imaging devices generating 3D datasets is typically handled by volume rendering the intensity and/or density values (for example, Hounsfield Units (HU) in the case of Computed Tomography (CT) for instance). Many clinical applications are based on three-dimensional (3D) visualization of the volumetric data; these include advanced lung analysis, advanced vessel analysis, cardiac, CT colonography, and the like. These applications rely on the values of the image data (intensity or density) to display 3D rendering of selected anatomies using thresholding techniques to identify them from the remaining data. Some of these applications are used routinely to screen for cancer in the form of tumors. Radiologists search for nodules and polyps in the lung and colon using methodologies such as Advanced Lung Analysis (ALA) and Computed Tomography Colonography (CTC).

Radiologists currently detect nodules in the lung by viewing the axial image slices of the chest. This approach is time consuming and becomes more time consuming with increasing numbers of CT slices. Detection is followed by an analysis for characterization of the nodule with the help of ALA's segmentation, volume measurement, and reporting tools.

Recently algorithms have been reported in the literature that utilize the matched filtering and rotation invariant aspect of the Hessian matrix to enhance spherical and cylindrical shapes in a volumetric image. Application of these filters on volumetric datasets e.g., chest CT exams, provide additional cues to the radiologist in making their diagnosis. Unfortunately, most of theses algorithms require a high computational cost and the reported times needed to produce the filtered responses are on the order of minutes even with relatively small (e.g., 45 slices with a matrix size of 400×400) data sets. For radiologists to benefit from these filters they need to run in near real-time (typically, 5-20 seconds) for all slice thicknesses (the datasets will range from 130 to 450+ slices). Therefore, what is needed in the art is a method for providing near real-time filtering on multidimensional volumetric datasets.

### BRIEF DESCRIPTION OF THE INVENTION

The above discussed and other drawbacks and deficiencies are overcome or alleviated by the exemplary embodiments including a method for processing of a multi-dimensional dataset corresponding to an imaging volume. The method comprises: accessing the multi-dimensional dataset; generating a plurality of differential operators for the multi-dimensional dataset using a discrete approximation of an analytic function; and forming a plurality of geometric responses based on a plurality of differential operators resultant from the generating. The method optionally further includes isolating a selected region of interest from the multi-dimensional dataset; the selected region of interest comprising a subset of the imaging volume.

Furthermore, the method optionally includes isolating lung tissue for a pair of lungs comprising: filtering with a high threshold algorithm to isolate solid tissue and bone; filling holes with a three-dimensional hole filling algorithm to fill a portion of remain contained inside the solids; filtering with a low threshold algorithm to isolate parenchyma of a pair of lungs from the solid tissue and bone; splitting and isolating the pair of lungs with a morphology erosion algorithm; closing and filing airways and vascular structures entering the pair of lungs with a morphology closure algorithm; and filling remaining holes with a three-dimensional hole filling algorithm to yield another multidimensional dataset corresponding to the selected region of interest.

Also disclosed herein in an exemplary embodiment is a method for processing of a multi-dimensional dataset corresponding to an imaging volume, the method comprising: processing the multidimensional dataset with multi-resolution sampling to establish a downsampled multidimensional dataset; identifying a region of interest from the multi-dimensional dataset; the region of interest comprising a subset of the imaging volume; and processing the downsampled multidimensional dataset based on the region of interest and establishing a multi-dimensional datasubset. The method also includes: filtering the multi-dimensional datasubset with a smoothing kernal based on an analytic function; the smoothing kernal generating a filtered multi-dimensional datasubset; generating a plurality of differential operators for the multi-dimensional datasubset using a discrete approximation of an analytic function; and forming a plurality of geometric responses based on a plurality of differential operators resultant from the generating.

Furthermore, disclosed herein in another exemplary embodiment is a method for processing of a multi-dimensional dataset in a multi-resolution framework comprising: isolating a selected region of interest from the multidimensional dataset and establishing a multidimensional datasubset, the selected region of interest comprising a subset of the imaging volume; convolving the multi-dimensional datasubset with an analytic function to obtain a first convolution product; and determining a plurality of discrete derivative approximations to an analytic function and optimizing the discrete derivative approximations in a least squares sense to reduce an error between the plurality of discrete derivative approximations and an analytical derivative of the analytic function. The method also includes: convolving the first convolution product with the plurality of discrete approximations of partial derivatives of an analytic function to create a plurality of second convolution products; forming a plurality of Hessian matrices from the plurality of second convolution products; determining a plurality of eigenvalue decompositions for the plurality of the Hessian matrices; and combining eigenvalues resultant from the decompositions to represent spherical and cylindrical responses to elements of the multidimensional datasubset.

Disclosed herein in yet an exemplary embodiment is a system for processing of a multi-dimensional dataset corresponding to an imaging volume, the system comprising: a means for accessing the multi-dimensional dataset; a means for generating a plurality of differential operators for the multi-dimensional dataset using a discrete approximation of an analytic function; and a means for forming a plurality of geometric responses based on a plurality of differential operators resultant from the generating.

Also disclosed herein in yet an exemplary embodiment is a system for processing of a multi-dimensional dataset corresponding to an imaging volume, the system comprising: an imaging system comprising; a radiation source configured to generate a radiation beam incident upon an object, a radiation detector, the radiation detector configured to receive an attenuated radiation beam responsive to the radiation beam incident upon the object and produce an electrical signal responsive to an intensity of attenuated radiation beam. The radiation source and the radiation detector disposed about an object cavity. The system also includes a processing device in operable communication with the radiation detector configured to execute a method for processing of a multi-dimensional dataset corresponding to an imaging volume, the method comprising; accessing the multi-dimensional dataset, generating a plurality of differential operators for the multi-dimensional dataset using a discrete approximation of an analytic function, and forming a plurality of geometric responses based on a plurality of differential operators resultant from the generating the plurality of differential operators.

Furthermore, disclosed herein in an exemplary embodiment is a computer usable storage medium, the computer usable storage medium including computer readable program code, the computer readable program code for executing the abovementioned method of processing of a multi-dimensional dataset corresponding to an imaging volume.

In addition, disclosed herein in another exemplary embodiment is a computer data signal, the data signal comprising code configured to cause a controller to implement the abovementioned method for processing of a multi-dimensional dataset corresponding to an imaging volume.

Finally, disclosed herein in yet another exemplary embodiment is a computer program code embodied in a computer readable form configured to cause a computer to implement the abovementioned method for processing of a multi-dimensional dataset corresponding to an imaging volume.

The above discussed and other features and advantages of the present invention will be appreciated and understood by those skilled in the art from the following detailed description and drawings.

### BRIEF DESCRIPTION OF THE DRAWINGS

Referring to the exemplary drawings wherein elements are numbered alike in the several Figures:

FIG. 1 shows an exemplary CT imaging system and a patient disposed for imaging;

FIG. 2 is a block schematic diagram of an exemplary CT imaging system;

FIG. 3 depicts a flowchart of the processing methodology in accordance with an exemplary embodiment of the invention;

FIG. 4 is a block diagrammatic depiction of the processing methodology in accordance with an exemplary embodiment of the invention;

FIG. 5 depicts a flowchart of the processing methodology for isolating a region of interest in accordance with an exemplary embodiment of the invention; and

FIG. 6 is a pictorial depiction of the processing methodology for isolating a region of interest in accordance with an exemplary embodiment of the invention.

### DETAILED DESCRIPTION OF THE INVENTION

Disclosed herein in the exemplary embodiments are a system and methodologies that enable a real-time implementation of shape filtering methods that employ higher order (e.g., greater than one) derivatives on anisotropic multidimensional datasets. The algorithms employed will be illustrated for the case of Hessian filtering to enhance spherical and cylindrical shapes in CT scans of the chest. While an exemplary system and methodology of filtering and processing such data is disclosed with reference to a computed tomography (CT) imaging system, it will be appreciated that such disclosure is illustrative only, it should be understood that the method and system of the disclosed invention may readily be applied to other imaging systems, such as Magnetic Resonance Imaging (MRI) systems. It should further be noted that the exemplary embodiments include determination of discrete approximations for the higher order derivatives in the case of anisotropic 3D volumes has applications in a variety of imaging fields including, but not limited to vessel analysis, colon and heart vessel segmentation, and the like.

Existing Hessian filtering approaches employ filtering of the entire 3D volume, generally with six 3D filters to generate the independent terms of the Hessian matrix. These approaches are computationally very expensive as well as resource intensive for memory and processing requirements. The exemplary embodiments disclosed herein describe a methodology that reduces both the number of filtering steps as well as the size of the dataset to be filtered. To accomplish such a reduction and enhancement in processing three processing techniques are utilized. First, in an exemplary embodiment, the methodology operates on a region of interest comprising a subset of the total 3D image volume. Selection of a region of interest (ROI) results in a reduced volumetric dataset. A second technique is application of multi-resolution sampling to further reduce dataset size. Third, optimal discrete approximations of analytic functions that minimize the squared error between the 3D derivative of the Gaussians and their discrete approximation are established and utilized. A technical effect of the exemplary embodiments is a real-time implementation of shape filtering methods that employ higher order (e.g., greater than one) derivatives on anisotropic multidimensional datasets.

For the illustrative example employing CT of the lung, the computational timesavings achieved with these individual methodologies are significant compared to existing techniques. Using the ROI reduction scheme alone, (e.g., only operating in a selected region of the lung, which is about 15-20% of the whole 3D volume) reduces the computation time by a factor of five. Likewise, employing multi-resolution sampling can provide a reduction in computation time by a factor of eight. Finally, using a discrete approximation of the higher order derivatives reduces memory requirements by a factor of six and improves processing times by a factor of about four. Further optimizations related to the hardware and multi-threaded utilizations of multi-processor systems may provide additional reductions in computation time and hardware utilization comparable to the number of processors employed. Advantageously, in total, the innovations and algorithmic optimizations of the exemplary embodiments disclosed herein facilitate implementations with reductions of computation times by a factor of 40 and reductions in required memory footprint by a factor of 30.

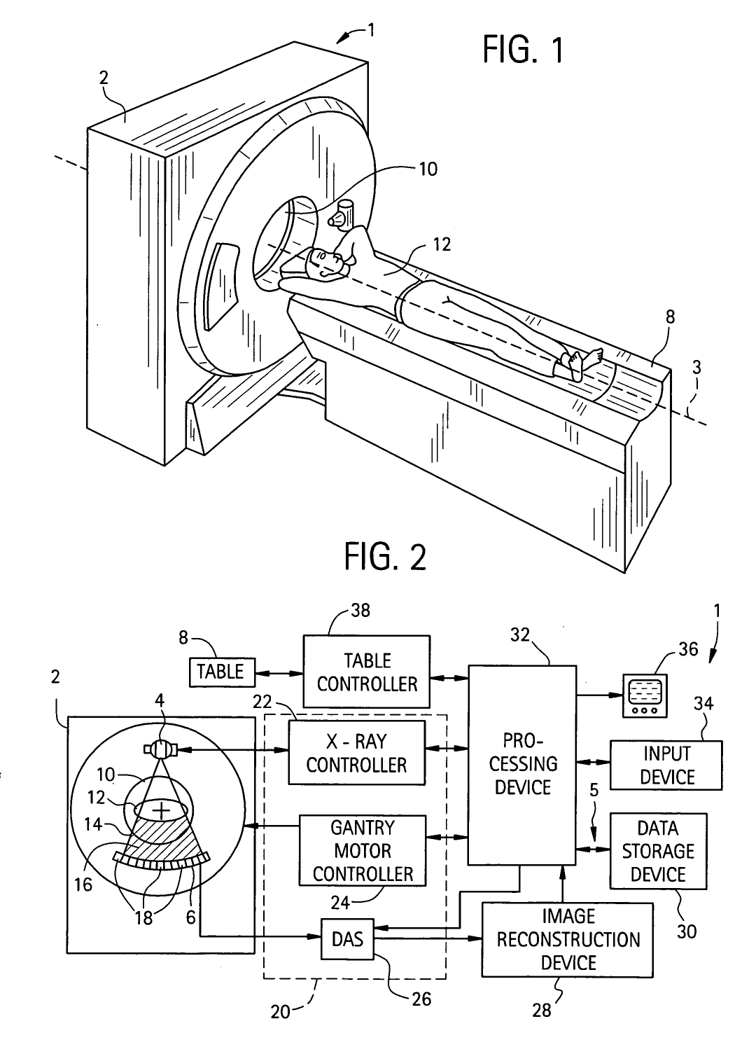

Referring now to FIG. 1 and FIG. 2, an exemplary CT imaging system 1 is shown that includes a gantry 2 having an radiation source 4 for example an x-ray source, a radiation detector 6, a patient support structure 8 and a object cavity 10, wherein the radiation source 4 and radiation detector 6 are opposingly disposed so as to be separated by object cavity 10. An object, such as a patient 12, is disposed upon a displaceable patient support structure 8 (“table”), which is then displaced along an axis 3 extending through object cavity 10. The radiation source 4 projects an radiation beam 14 toward radiation detector 6 so as to pass through patient 12. The radiation beam 14 is collimated by a collimate so as to lie within an X-Y plane of a Cartesian coordinate system referred to as an “imaging plane”. After passing through and becoming attenuated by patient 12, attenuated radiation beam 16 is received by the radiation detector 6. Radiation detector 6 includes a plurality of detector elements 18 wherein each of the detector elements 18 receives the attenuated radiation beam 16 and produces an electrical signal responsive to the intensity of attenuated radiation beam 16.

In addition, radiation source 4 and radiation detector 6 are rotatingly disposed relative to gantry 2 and patient support structure 8, so as to allow the radiation source 4 and the radiation detector 6 to rotate around patient support structure 8 when patient support structure 8 is disposed within object cavity 10. Radiation projection data is obtained by rotating the radiation source 4 and radiation detector 6 around patient 10 during a scan. Helical radiation projection data is obtained by additionally displacing patient 8 along an axis 3. Radiation source 4 and radiation detector 6 communicate with a control mechanism 20 associated with CT imaging system 1. Control mechanism 20 controls the rotation and operation of the radiation source 4 and the radiation detector 6.

Control mechanism 20 includes an x-ray controller communicating with x-ray source, a gantry motor controller 24, and a data acquisition system (“DAS”) 26. DAS 26 communicates with the radiation detector 6. Radiation controller 22 provides power and timing signals to radiation source 4, gantry motor controller 24 controls the rotational speed and angular position of radiation source 4 and DAS 26 receives the electrical signals produced by detector elements 18 and converts the signals into data signals for subsequent processing. CT imaging system 1 includes an image reconstruction device 28, a data storage device 30 and a processing device 32, wherein processing device 32 communicates with image reconstruction device 28, gantry motor controller 24, radiation controller 22, data storage device 30, input device 34 and output device 36. Data storage device 30 comprises any computer usable storage medium known to one of ordinary skill in the art and is in communication with processing device 32 via a propagated signal 5. CT imaging system 1 also includes a table controller 38 communicated with processing device 32 and patient support structure 8, so as to control the position of patient support structure 8 relative to object cavity 10.

Patient 12 is preferably disposed on patient support structure 8, which is then positioned by an operator via processing device 32 so as to be displaceable within object cavity 10. Gantry motor controller 24 is operated via processing device 32 to cause radiation source 4 and radiation detector 6 to rotate relative to patient 12. Radiation controller 22 is operated via processing device 32 so as to cause radiation source 4 to emit and project a collimated radiation beam 14 toward radiation detector 6 and hence toward patient 12. Radiation beam 14 passes through patient 12 to create an attenuated radiation beam 16, which is received by radiation detector 6.

Detector elements 18 receive attenuated radiation beam 16, produce electrical signals responsive to the intensity of attenuated radiation beam 16 and propagates this electrical signal data to DAS 26. DAS 26 then converts the electrical signals to data signals and communicates the data signals to image reconstruction device 28. Image reconstruction devices 28 perform high-speed image reconstruction. Reconstructed images 32 are stored in data storage device 30 and are displayed via output device 36.

In order to perform the prescribed functions and desired processing, as well as the computations therefore (e.g., the execution of the multi-resolution sampling, segmentation, smoothing and derivative prescribed herein, and the like), processing device 32 and/or image reconstruction device 28 may include, but not be limited to, a processor(s), computer(s), memory, storage, register(s), timing, interrupt(s), communication interfaces, and input/output signal interfaces, as well as combinations comprising at least one of the foregoing. Processing device 32 and/or image reconstruction device 28 may also include inputs and input signal filtering and the like, to enable accurate sampling and conversion or acquisitions of signals from communications interfaces and inputs. Additional features of processing device 32 and/or image reconstruction device 28 and certain processes therein are thoroughly discussed at a later point herein.

One or more embodiments of the invention may be implemented as new or updated firmware and software executed in processing device 32 and/or other processing controllers. Software functions include, but are not limited to firmware and may be implemented in hardware, software, or a combination thereof. Thus a distinct advantage of the present invention is that it may be implemented for use with existing and/or new CT imaging system 1 or other imaging systems.

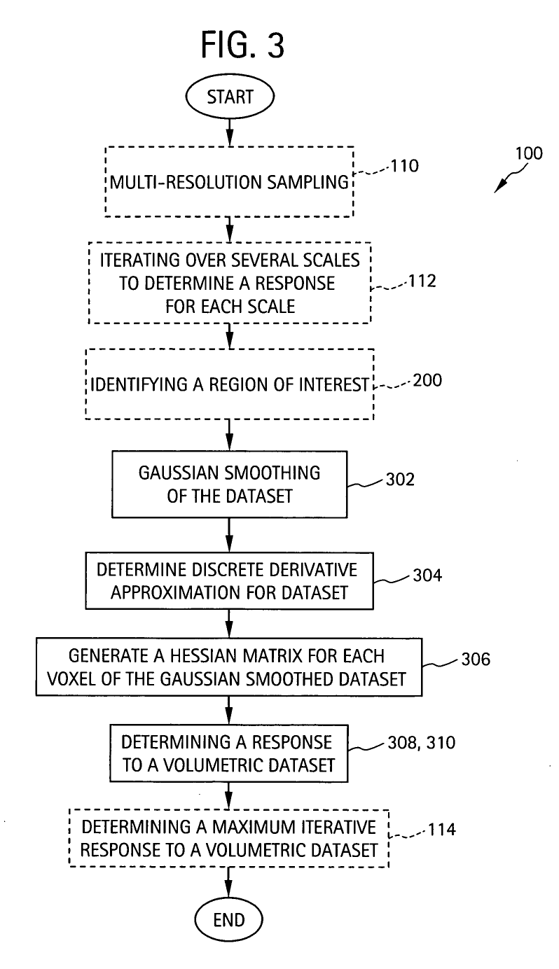

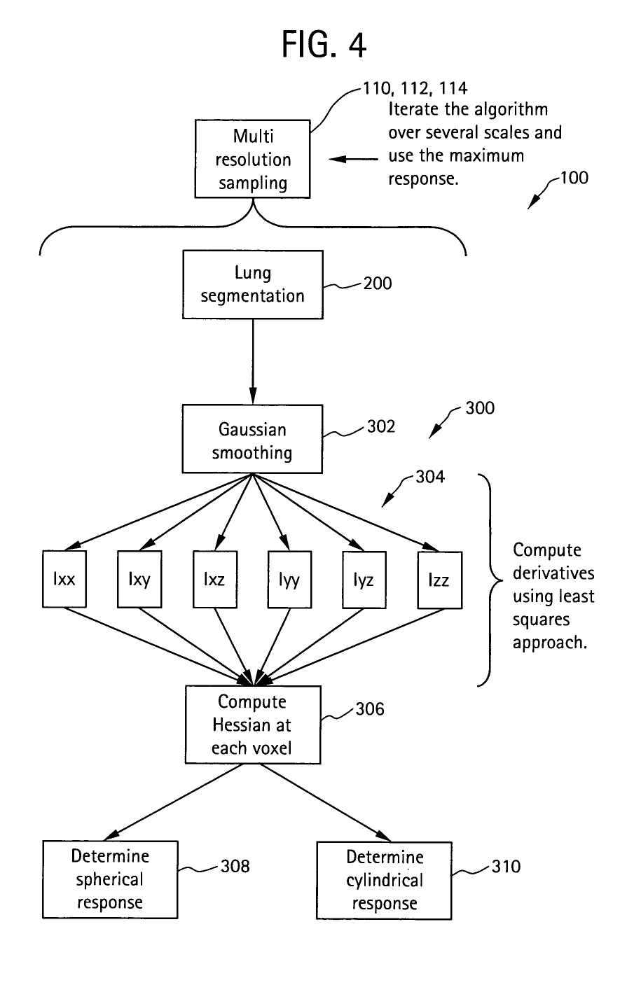

FIGS. 3 and 4 show a simplified block diagram and a flow chart depicting steps for processing a multidimensional image dataset in accordance with an exemplary embodiment. It is understood that several embodiments described herein thus far are applicable to and may be implemented in combination with the steps and processes described herein and in FIGS. 3 and 4 without exceeding the scope of the present disclosure. Turning now to FIG. 4, a flowchart depicting a methodology 100 for optimizing processing of a multidimensional dataset in accordance with an exemplary embodiment is depicted. In an exemplary embodiment, the methodology employs multi-resolution sampling and operates on a selected region of interest comprising a subset of the total 3D image volume. Selection of a region of interest of the total volume results in a reduced volumetric dataset. For the illustrative example of the lung, the resulting volume for the ROI comprises approximately 15-20% of the total volume of a typical CT Chest exam. The ROI is identified using anatomical density values of the lung in association with morphological operations to isolate a portion of interest from the total volume dataset.

Continuing with FIGS. 3 and 4, the methodology 100 for optimizing processing of a multidimensional dataset initiates with multi-resolution sampling in accordance with an exemplary embodiment as depicted at process block 110. Multi resolution sampling is utilized so that the volume being imaged may be represented at different scales and thereby, facilitate scale-space processing. In addition, the methodology 100 further includes iterating the processes 112 herein over several scales to identify a desired response, and thereby achieve the best results even with a reduced computation time relative to existing methodologies. For example, downsampling may be employed to adjust scaling to accommodate various sizes of objects of interest in the image dataset, e.g., various sized nodules in the lung. In one exemplary embodiment, various forms of downsampling are employed in conjunction with a volume Segmentation methodology for identifying a region of interest 200 to reduce the volume processed. Downsampling methodologies may include but not be limited to decimation, wavelet decomposition, averages of local intensities, and the like, as well as combinations including at least one of the foregoing. The downsampling can be employed selectively in the plane (XY) domain or the full 3D domain. It will be appreciated that downsampling in the XY domain is useful, for instance, if the plane (or slice) thickness is greater than the in-plane voxel-size. Downsampling in XY can provide an approximately isotropic volume for further processing.

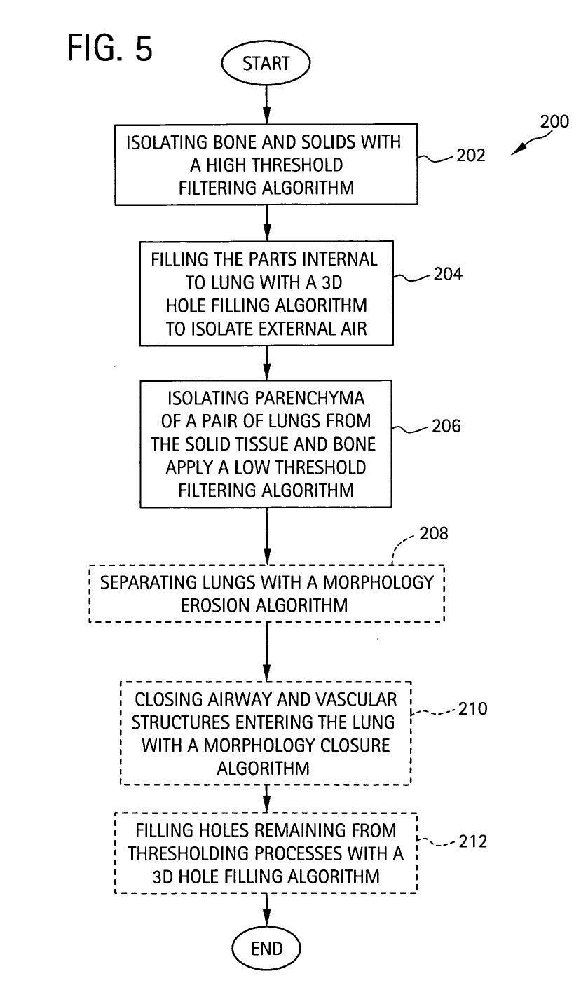

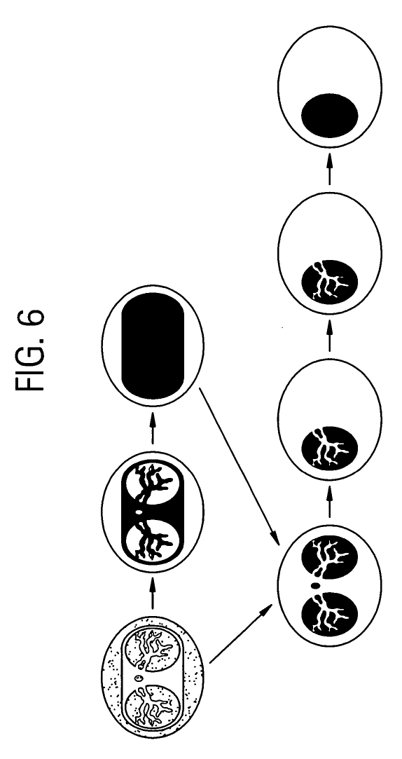

Turning now to FIGS. 5 and 6, in another exemplary embodiment, a methodology 200 for identifying the ROI, e.g., a desired or target lung volume, is depicted. The methodology employs thresholding techniques and morphology processes to constrain the volume to be later processed. It will be appreciated that a desired target volume would preferably include only that portion of the total volume that is needed for further evaluation without the surrounding tissue, bone, air and the like. The methodology is initiated by isolating solid tissue and bone by performing a high threshold scan of the entire volume e.g., the entire lung/chest volume to images of as depicted at process block 202. In other words, to identify the anatomical parts around the lungs. In an exemplary embodiment a threshold above −300 HU is employed for CT imaging. As depicted at process block 204, a 3D hole filling algorithm is then employed to fill the parts contained inside the lung, air, solid tissue and bone (i.e. lungs) identified it process 202. This isolates the body from the surrounding air in the overall image volume, constraining the volume to just the body of the patient without the surrounding air.

The methodology 200 continues at process 206 with isolating the lung parenchyma from the surrounding anatomical parts, solid structures e.g., bone, muscle, by performing a low threshold (e.g. below −300 HU) scan of the remaining volume from the process 202 to identified in process 202 above. Additionally, if necessary, the lungs are separated using a morphology erosion to eliminate any connection resulting from the partial voluming as depicted at process block 208, and thereby providing separation of the two lung volumes. The methodology 200 also continues with a process block 210 wherein a morphology closure is optionally utilized, if necessary, to close protrusions to the lungs, e.g., airway and vascular structures entering the lungs. Finally, as depicted at process block 212, a 3D hole-filling algorithm is optionally employed, once again, to fill in the any holes remaining from the threshholding processes yielding a final volume of the lung tissue alone. Advantageously, the segmented lung presents a significantly reduced volumetric dataset that may be further processed as disclosed herein.

Returning now to FIGS. 3 and 4 the methodology 100 for optimizing processing of a multidimensional dataset in accordance with an exemplary embodiment further includes establishing a discrete finite kernal, that when convolved with a given dataset produces a result that approximates the analytical n-th order derivative of the dataset. A smoothing function 302 is applied to the image data to eliminate noise and constrain scale. In an exemplary embodiment, a Gaussian function is employed for the smoothing function 302. Moreover, it will be appreciated that applying a derivative and/or second derivative of the Gaussian has several uses in image processing such as edge detection, Hessian computation, and the like. Such derivatives e.g., the Hessian matrix, are employed for filtering to facilitate distinguishing between nodules, vessels, tissue, and the like. It will be appreciated that in a one-dimensional case, the derivative is a relatively simple operation. However, as dimensionality is increased, determining an analytical derivative of the Gaussian filter becomes more computationally intensive as filtering needs to be applied in each dimension. For example, Hessian computation in a volumetric dataset, requires six distinct 3-dimensional filters to be applied to the volume, each exhibiting a relatively large kernal size. The computation of the six filters and application to the dataset requires significant computational time and expense.

To reduce the computational complexity associated with computing the Hessian matrix, in an exemplary embodiment, a discrete approximation of the analytical derivatives (six are depicted for an exemplary 3D case) of a Gaussian filter is determined. Moreover, the discrete approximation is configured to decouple the Gaussian smoothing 302 and the derivative computation 304 into two steps that are optionally separated. Thus, in an exemplary embodiment, instead of applying a single large kernal derivative of a Gaussian filter to the volumetric dataset, one large Gaussian kernal for smoothing 302 followed by a derivative operator 304 with a much smaller kernal size is applied to the volume. The advantages of this approach are readily apparent with the multidimensional dataset. More particularly, if multiple derivatives need to be taken as in the case of higher dimensional problems, the output of applying the Gaussian kernal 302 may be reused and only a smaller derivative kernal 304 needs to be applied to the volume for each derivative. This multi-step approach permits a significant improvement in computational speed, particularly if the actual analytical derivative of the Gaussian has a large kernal size. It will be appreciated that while in an exemplary embodiment a Gaussian function is described and employed, other analytic functions are possible. In general, any analytic function that is both continuous and differentiable may be employed for the processes disclosed herein.

In an exemplary embodiment, to compute the appropriate derivative kernal 304, the problem is transformed into an optimization problem. Since the analytical forms of the Gaussian and its derivative are known, and, because convolution is an associative operation, the problem of computing the derivatives 304 can be broken down into finding the optimal n-point derivative kernal that when convolved with the Gaussian will approximate the derivative of the Gaussian. Preferably, in an exemplary embodiment a least squares approximation is employed, which is optimized in the squared error sense such that the error between the approximation and the actual analytical derivative of the Gaussian is minimized. It will be appreciated that in an exemplary embodiment a least square approximation is employed. However, other optimizations may be employed. It will also be appreciated that while a goal of any optimization/minimization is to eliminate the error it is well known that an optimization is directed to an ideal of approaching an exact solution without necessarily exactly attaining that solution. Optimizations that employ a userselected threshold may also be employed. For example, in one exemplary embodiment, a threshold of the order of ten percent is employed. The derivative kernal is approximated by solving for αᵢ in the following relation:

$$arg min ( {a}_{i} ) \{ {\sum }_{{neS}_{g}} {( {\sum }_{i - 2 p - 1}^{2 p + 1} ( {a}_{i + 2 p + 1} g [ n - i ] ) - {g}^{′} [ n ] )}^{2} \} , \qquad ( 1 )$$

where
aᵢ is the ith discrete derivative approximation,
nεS_{g} means is in the Support S_{g} of the Gaussian g[n] kernal and its deravitive g′[n].
p defines the size of the discrete derivative kernal
g[n] is a data sample from the Gaussian smoothed dataset,
g′[n] is derivative of the Gaussian smoothed data sample, and
Using the known relationships for a Gaussian, it will be appreciated that:

$$\begin{matrix}g [ n \pm 1 ] = {ⅇ}^{\frac{( 2 n \pm 1 ) {T}^{2}}{2 {σ}^{2}}} g [ n ] , and & ( 2 ) \\ {g}^{′} [ n ] = - \frac{nT}{{σ}^{2}} g [ n ] , & ( 3 )\end{matrix}$$

where T is the sampling period and □ is the standard deviation of the Gaussian. equation (1) can be solved using standard optimization techniques. This will yield the optimal p-point derivative and will provide a reasonable approximate of the sampled analytical kernal. To improve the accuracy of the approximation, an exemplary 5-point or 7-point derivative can be computed employing the same techniques. It will be appreciated that these approaches can easily be extended to compute the optimal 2nd derivative or any other arbitrary higher order derivative of the Gaussian as desired.

Continuing with FIGS. 3 and 4, once the discrete derivative approximations 304 have been computed the Hessian is computed as depicted at process 306 for each voxel in the volume dataset, (and/or the sub-dataset for the region of interest as described above. Furthermore, the spherical and cylindrical responses are then computed as depicted at process blocks 308 and 310 respectively. It will be appreciated that this process of scaling, determining a region of interest, Gaussian smoothing and determining a response may be iteratively repeated for various scalings to acquire an optimal response for the volumetric dataset as depicted at process block 114.

It will be appreciated that while in an exemplary embodiment, three processes are disclosed and employed to facilitate real time processing of the volumetric data set all three are not necessarily required to achieve the desired result of achieving near real-time processing of the dataset. Further, while the exemplary embodiments are described and depicted in a particular order, for convenience, no particular order is mandated. For example, while the multi-resolution sampling in is depicted as preceding the determination a region of interest 200, these processes may readily be reversed. Furthermore, although the preceding embodiments are discussed with respect to medical imaging, it is understood that the image acquisition and processing methodology described herein is not limited to medical applications, but may be utilized in non-medical applications.

The description applying the above embodiments is merely illustrative. As described above, embodiments in the form of computer-implemented processes and apparatuses for practicing those processes may be included. Also included may be embodiments in the form of computer program code containing instructions embodied in tangible data storage device 30, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a propagated data signal 5 transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It will be appreciated that the use of first and second or other similar nomenclature for denoting similar items is not intended to specify or imply any particular order unless otherwise stated.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

1. A method for processing of a multi-dimensional dataset corresponding to an imaging volume, the method comprising:
accessing the multi-dimensional dataset;
generating a plurality of differential operators for the multi-dimensional dataset using a discrete approximation of an analytic function; and
forming a plurality of geometric responses based on a plurality of differential operators resultant from said generating.

2. The method of claim 1 further including scale-space processing the multi-dimensional dataset with multi-resolution sampling.

3. The method of claim 2 further comprising:
iterating said generating and forming over several scales to determine said plurality of responses for each scale; and
determining said plurality of geometric responses based on said iterating.

4. The method of claim 1 wherein said computing further includes:
filtering the multi-dimensional dataset with a smoothing kernal based on an analytic function; said smoothing kernal generating a filtered multi-dimensional dataset.

5. The method of claim 1 wherein said analytic function is a Gaussian.

6. The method of claim 1 wherein said plurality of differential operators correspond to an n-th derivative of said analytic function, where n is greater than or equal to one.

7. The method of claim 1 wherein said computing comprises:
identifying a plurality of discrete derivative approximations that when convolved with said analytic function, approximates an analytical derivative of said analytic function; and
optimizing said discrete derivative approximations in a least squares sense to reduce an error between said plurality of discrete derivative approximations and said analytical derivative of said analytic function.

8. The method of claim 1 further including isolating a selected region of interest from the multi-dimensional dataset; said selected region of interest comprising a subset of the imaging volume.

9. The method of claim 8 wherein said isolating a selected region of interest includes image threshold filtering and a morphology process configured to eliminate selected portions of the imaging volume.

10. The method of claim 8 and wherein said isolating a selected region of interest further includes isolating lung tissue for a pair of lungs comprising:
filtering with a high threshold algorithm to isolate solid tissue and bone;
filling holes with a three-dimensional hole filling algorithm to fill a portion of remain contained inside said solids;
filtering with a low threshold algorithm to isolate parenchyma of a pair of lungs from the solid tissue and bone;
splitting and isolating said pair of lungs with a morphology erosion algorithm;
closing and filing airways and vascular structures entering said pair of lungs with a morphology closure algorithm; and
filling remaining holes with a three-dimensional hole filling algorithm to yield another multidimensional dataset corresponding to the selected region of interest.

11. The method of claim 3 further including generating a downsampled multidimensional dataset based on said multi-resolution sampling.

12. The method of claim 11 further including isolating a selected region of interest from at least one of said multi-dimensional dataset and said downsampled multi-dimensional dataset, said selected region of interest comprising a subset of the imaging volume.

13. The method of claim 11 wherein said isolating a selected region of interest includes image threshold filtering and a morphology process configured to eliminate unnecessary portions of the imaging volume.

14. The method of claim 1 wherein said processing of a multi-dimensional dataset is executed in less than one minute.

15. A method for processing of a multi-dimensional dataset corresponding to an imaging volume, the method comprising:
processing the multidimensional dataset with multi-resolution sampling to establish a downsampled multidimensional dataset;
identifying a region of interest from the multi-dimensional dataset; said region of interest comprising a subset of the imaging volume;
processing said downsampled multidimensional dataset based on said region of interest and establishing a multi-dimensional datasubset;
filtering the a multi-dimensional datasubset with a smoothing kernal based on an analytic function; said
smoothing kernal generating a filtered multi-dimensional datasubset;
generating a plurality of differential operators for the multi-dimensional datasubset using a discrete approximation of an analytic function; and
forming a plurality of geometric responses based on a plurality of differential operators resultant from said generating.

16. A method for processing of a multi-dimensional dataset in a multi-resolution framework comprising:
isolating a selected region of interest from said multidimensional dataset and establishing a multidimensional datasubset, said selected region of interest comprising a subset of the imaging volume;
convolving said multidimensional datasubset with an analytic function to obtain a first convolution product;
determining a plurality of discrete derivative approximations to an analytic function and optimizing said discrete derivative approximations in a least squares sense to reduce an error between said plurality of discrete derivative approximations and an analytical derivative of said analytic function;
convolving said first convolution product with the plurality of discrete approximations of partial derivatives of an analytic function to create a plurality of second convolution products;
forming a plurality of Hessian matrices from said plurality of second convolution products;
determining a plurality of eigenvalue decompositions for said plurality of said Hessian matrices; and
combining eigenvalues resultant from said decompositions to represent spherical and cylindrical responses to elements of said multidimensional datasubset.

17. A system for processing of a multi-dimensional dataset corresponding to an imaging volume, the system comprising:
a means for accessing the multi-dimensional dataset;
a means for generating a plurality of differential operators for the multi-dimensional dataset using a discrete approximation of an analytic function; and
a means for forming a plurality of geometric responses based on a plurality of differential operators resultant from said generating.

18. A system for processing of a multi-dimensional dataset corresponding to an imaging volume, the system comprising:
an imaging system comprising;
a radiation source configured to generate a radiation beam incident upon an object,
a radiation detector, said radiation detector configured to receive an attenuated radiation beam responsive to said radiation beam incident upon said object and produce an electrical signal responsive to an intensity of attenuated radiation beam, and
wherein said radiation source and said radiation detector disposed about an object cavity;
a processing device in operable communication with said radiation detector configured to execute a method for processing of a multi-dimensional dataset corresponding to an imaging volume, the method comprising;
accessing the multi-dimensional dataset,
generating a plurality of differential operators for the multi-dimensional dataset using a discrete approximation of an analytic function, and
forming a plurality of geometric responses based on a plurality of differential operators resultant from said generating.

19. A computer data storage device, said computer data storage device including computer readable program code, the computer readable program code comprising a method for processing of a multi-dimensional dataset corresponding to an imaging volume, the method comprising:
accessing the multi-dimensional dataset;
generating a plurality of differential operators for the multi-dimensional dataset using a discrete approximation of an analytic function; and
forming a plurality of geometric responses based on a plurality of differential operators resultant from said generating.

20. A computer data signal, said data signal comprising code configured to cause a processing device to implement a method for processing of a multi-dimensional dataset corresponding to an imaging volume, the method comprising:
accessing the multi-dimensional dataset;
generating a plurality of differential operators for the multi-dimensional dataset using a discrete approximation of an analytic function; and
forming a plurality of geometric responses based on a plurality of differential operators resultant from said generating.

21. A computer program code embodied in a computer readable form configured to cause a computer to implement a method for processing of a multi-dimensional dataset corresponding to an imaging volume, the method comprising:
accessing the multi-dimensional dataset;
generating a plurality of differential operators for the multi-dimensional dataset using a discrete approximation of an analytic function; and
forming a plurality of geometric responses based on a plurality of differential operators resultant from said generating.
